(19) United States
(12) Patent Application Publication
(10) Pub. No.: US 2008/0110883 A1
(43) Pub. Date: May 15, 2008

(54) Trash can cleaning lid

(76) Inventors: Douglas J. Vetter, Newton, NJ (US); Phillip W. Vetter, Hopatcong, NJ (US)

Correspondence Address: THOMAS J. GERMINARIO, ESQ., 154 ROUTE 206, CHESTER, NJ, 07930, US

(21) Appl. No.: 11/979,383

(22) Filed: Nov. 2, 2007

Related U.S. Application Data
(60) Provisional application No. 60/858,413, filed on Nov. 13, 2006.

(51) Int. Cl. B65F 7/00; B08B 9/093; B65D 51/24

(52) U.S. Cl. 220/87.1; 220/212

(57) ABSTRACT

A trash can lid has incorporated in it an apparatus for coupling to and receiving water from a hose and conveying the water to a spray-head mechanism, wherein the water is pressurized and from whence the pressurized water is directed against the angled blades of rotary water-deflector, such that a rotary spray of pressurized water is directed against the interior walls of the trash can, thereby flushing wastes from the walls to the bottom of the trash can.

### CROSS-REFERENCE TO RELATED APPLICATION

This application claims the benefit of the filing date of Provisional Application No. 60/858,413, filed on Nov. 13, 2006.

### FIELD OF THE INVENTION

This invention relates to a specially designed cover (hereafter referred to as a “lid”) of a solid waste receptacle (hereafter referred to as a “trash can”), which lid has incorporated within it an apparatus by which the interior of the trash can be washed, disinfected, deodorized and sanitized, and by which the residual wastewater and solid debris remaining after such washing can be disposed of without the need for human contact with either residual.

### BACKGROUND OF THE INVENTION

One of the most unpleasant and unsanitary of recurring household tasks is the cleaning of trash cans. As a result of leaking or improperly sealed trash bags or careless handling, wastes accumulate over time on the walls and bottom of a trash can. Such wastes, if left to accumulate and decompose, become a source of odors and a breeding ground for disease-spreading organisms, insects and vermin.

The typical method employed to clean domestic trash cans involves flushing the interior of an open trash can with water sprayed from a garden hose and then dumping the residual wastewater and debris out on the ground. This method is very unsanitary because the contaminated backsplash from the spray impacting the interior of the trash comes into contact with exposed skin and clothing. There is also the attendant unsanitary procedure of picking up the dumped debris by hand and placing it in a trash bag.

The prior art discloses several devices designed to diffuse a deodorizer, disinfectant and/or pesticide into the interior of a trash can. Examples of such devices are described in Cunningham, U.S. Pat. No. 2,573,548, Almanza, U.S. Pat. No. 3,840,145, and Bitner, U.S. Pat. No. 5,988,520. While these inventions deal with the effects of accumulated wastes in trash cans, in terms of controlling resulting odors and infectious agents, they do not address the problem of cleaning the inside of a trash can in a safe and sanitary manner.

To the extent the prior art addresses the problem of washing the interior of trash cans, it teaches devices that are primarily directed to commercial use and designed for cleaning large numbers of trash cans. Such devices are complex, expensive, and require equipment not available to the average homeowner or apartment dweller. An example is the bin washer disclosed in Cooper, U.S. Pat. No. 6,336,239, in which a rotating stem with an array of spray nozzles and brushes driven by a hydraulic motor is inserted into an inverted trash can, with the residuals flowing into a catchment tank that filters the debris and recycles the wastewater. The Cooper apparatus is specifically designed to operate as a mobile cleaning system on a waste collection vehicle, and it is not suitable for household use.

More adaptable to domestic use is the apparatus taught by Rhodes, U.S. Pat. No. 6,758,880. While the Rhodes apparatus is designed to facilitate the decomposition of biodegradable materials, such as pet waste, rather than to clean the inside of a trash can, it has two features in common with the present invention: (a) a hose fitting for accepting and retaining the insertive coupler of a garden hose, and (b) a spray nozzle in fluid communication with the hose fitting for receiving water from the garden hose and spraying the water under pressure into the interior of a waste bin. But the configuration and orientation of the spray nozzle in Rhodes is not designed to remove waste from the wall and bottom of the waste bin, but rather to stir and fragment the biodegradable material within the bin in order to facilitate its decomposition.

There remains, therefore, a need not addressed by the prior art for a device suitable for domestic use which can clean the interior of a trash can while preventing human contact with deleterious waste matter. It is the purpose of the present invention to address that need.

### SUMMARY OF THE INVENTION

It is an object of the present invention to provide a trash can lid that has incorporated in it an apparatus for coupling to and receiving water from a hose and conveying the water to a spray-head mechanism, wherein the water is pressurized and from whence the pressurized water is directed against the angled blades of rotary water-deflector, such that a rotary spray of pressurized water is directed against the interior walls of the trash can, thereby flushing wastes from the walls to the bottom of the trash can.

It is another object of the present invention to provide as part of the aforesaid trash can lid apparatus a cleanser reservoir, located between the hose coupling and the spray-head mechanism, wherein can be stored a cleaning, deodorizing and/or disinfecting agent (hereafter referred to as the “cleanser”), such that the flow of water from the hose coupling mixes with the cleanser on its way to the spray-head mechanism, thereby infusing the rotary spray of pressured water directed against the walls of the trash can with cleanser and rendering said spray more effective in removing wastes from the walls of the trash can.

It is a further object of the present invention to provide in the trash can lid a debris strainer over which is slidably attached a cover plate, such that, when wastes from the walls of the trash can have been flushed into the bottom of the trash can, the trash can can be tilted on its side and the cover plate can be opened so that wastewater flows out but solid debris is caught in the strainer, thereby enabling disposal of the debris without direct human contact by removing the lid and dumping the debris into a garbage bag inserted in the freshly cleaned trash can.

It is yet another object of the present invention to provide a trash can cleaning lid that will prevent backsplash of spray from the cleaning of the interior of a trash can from coming into contact with exposed human skin or clothing.

It is yet a further object of the present invention to provide a trash can cleaning lid that will enable disposal of residual wastewater and debris from the cleaning of a trash can without the need for direct human contact with either residual.

It is still another object of the present invention to a provide a device for cleaning, deodorizing, disinfecting and sanitizing trash cans that is inexpensive, easy to operate, and suitable for domestic use.

It is yet a further object of the present invention to a provide a device for cleaning, deodorizing, disinfecting and sanitizing trash cans that is simple and has a minimum of moving parts, such that it is durable and requires little or no maintenance.

All of these and other beneficial objects and purposes are achieved by a trash can cleaning lid designed to fit snuggly over a conventional household trash can having an outer rim, interior walls and a bottom. The trash can cleaning lid comprises a basic lid, a plurality of cleaning mechanicals, and a debris strainer.

The basic lid is a conventional trash can lid comprising a disk-shaped top mantle from which downwardly depends a short vertical cylindrical side flange, and further comprising one or more handles which may be attached to either the top mantle or the side flange. The top mantle has an upper surface and an under surface, which two surfaces communicate through two round apertures: a water aperture and a cleanser aperture. The side flange has an exterior surface and an interior surface, the latter of which can optionally have one or more treads or ridges designed to cooperate with corresponding structures on the outer rim of the trash can.

The cleaning mechanicals comprise a hose coupling, a shut-off valve, a plurality of fluid transmission means, a cleanser reservoir, a spray-head mechanism, and a rotating water deflector. The hose coupling extends above the upper surface of the top mantle and consists of a fitting into which the male end of a standard garden hose can be inserted or screwed. Downstream of the hose coupling is the shut-off valve, which is one of the standard types used in plumbing. The fluid transmission means consist of a series of interconnected plumbing fittings, including elbows and T-joints, which form a continuous fluid conduit that conveys water from the shut-off valve though the water aperture, into the cleanser reservoir and then into the spray-head mechanism.

The cleanser reservoir extends through the cleanser aperture from above the upper surface to below the under surface of the top mantle. The spray-head mechanism is fastened to the under surface of the top mantle. The cleanser reservoir preferably comprises a reservoir fitting, which can be a T-joint fitting, and a filling fitting, which extends though the cleanser aperture and projects above the upper surface of the top mantle, such that a cleanser can be poured through the filling fitting into the reservoir fitting. The flow of water from the hose coupling mixes with the cleanser in the reservoir fitting so that a water/cleanser emulsion flows out of the reservoir fitting into the spray-head mechanism.

The spray-head mechanism comprises a chamber and a nozzle, the latter of which constricts the flow of water/cleanser emulsion and thereby increases its pressure. The nozzle directs a concentrated jet of pressurized water/cleanser emulsion downward to the rotary water deflector, which preferably comprises a plurality of angled blades rotatably attached to a common axis. The rotary water deflector propagates a rotary spray of pressurized water/cleanser emulsion against the interior walls of the trash can, thereby flushing wastes from the interior walls to the bottom of the trash can.

The debris strainer comprises a filtering means, which consists of one or more openings in the top mantle, some or all of which openings can encompass or be covered by a metal, plastic or fabric mesh, screen, filter or sieve. Over the filtering means is slidably attached a cover plate. When the cover plate is in the closed position, it forms a water-tight seal over the filtering means. When the cover plate is in the open position, liquids may flow through the filtering means from the inside of the trash can, but solid debris is retained by the filtering means. When the shut off valve is opened and the trash can is being cleaned, the cover plate is kept in the closed position to prevent contaminated liquid from escaping. After all wastes have been flushed from the interior walls to the bottom of the trash can, the shut-off valve is closed and the hose is disconnected from the hose coupling. Then the cover plate is opened and the trash can is tilted to a semi-inverted position to allow filtered wastewater to flow out of the trash can. The lid is then removed from the trash can, and the debris trapped in the debris strainer is dumped into a garbage bag inserted in the freshly cleaned trash can.

A better understanding of the present invention will be gained by referring to the drawings and the detailed description of the preferred embodiment which follows.

### BRIEF DESCRIPTION OF THE DRAWINGS

FIG. 1 is a perspective view of a trash can cleaning lid according to the preferred embodiment of the present invention as seen from the top.

FIG. 2 is a side elevation view of a trash can cleaning lid according to the preferred embodiment of the present invention.

FIG. 3 is a perspective view of a trash can cleaning lid according to the preferred embodiment of the present invention as seen from the bottom.

### DETAILED DESCRIPTION OF THE PREFERRED EMBODIMENT

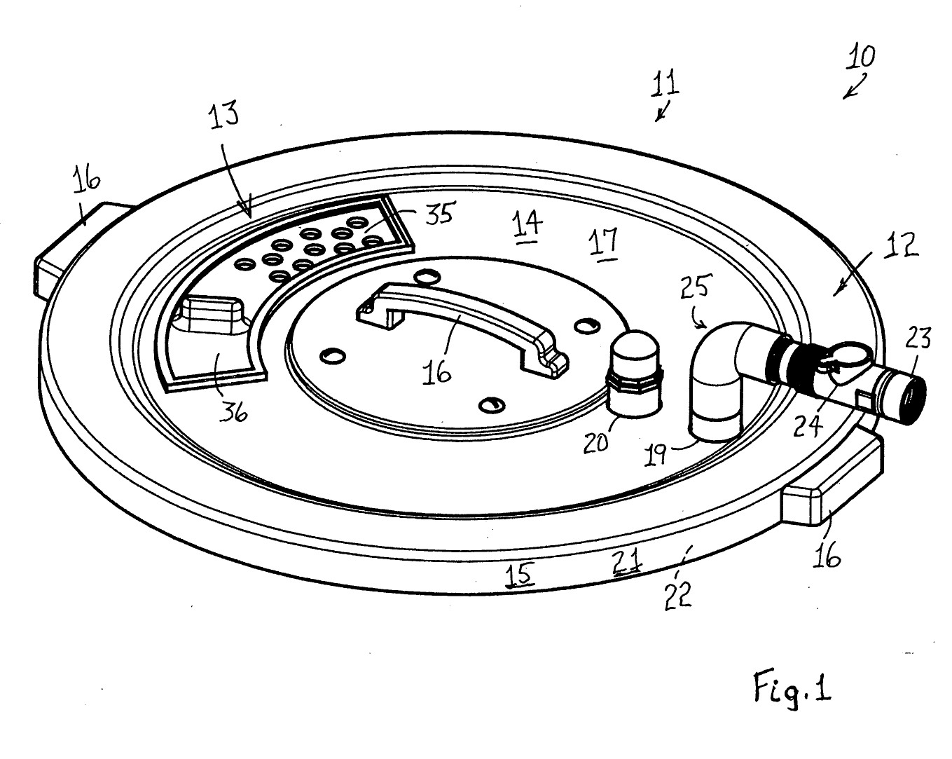

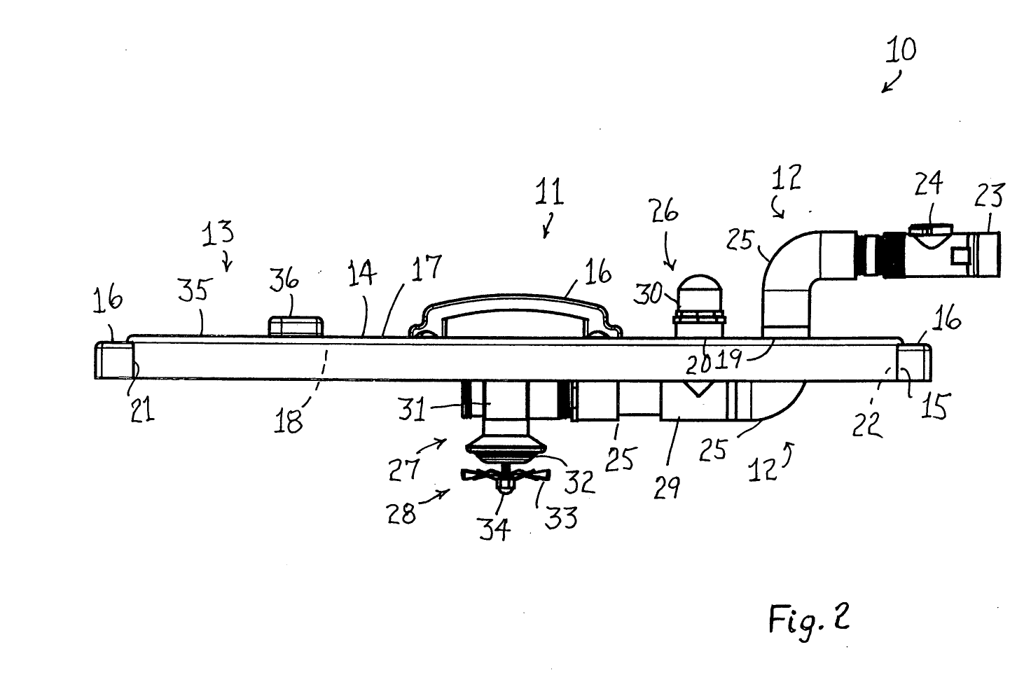

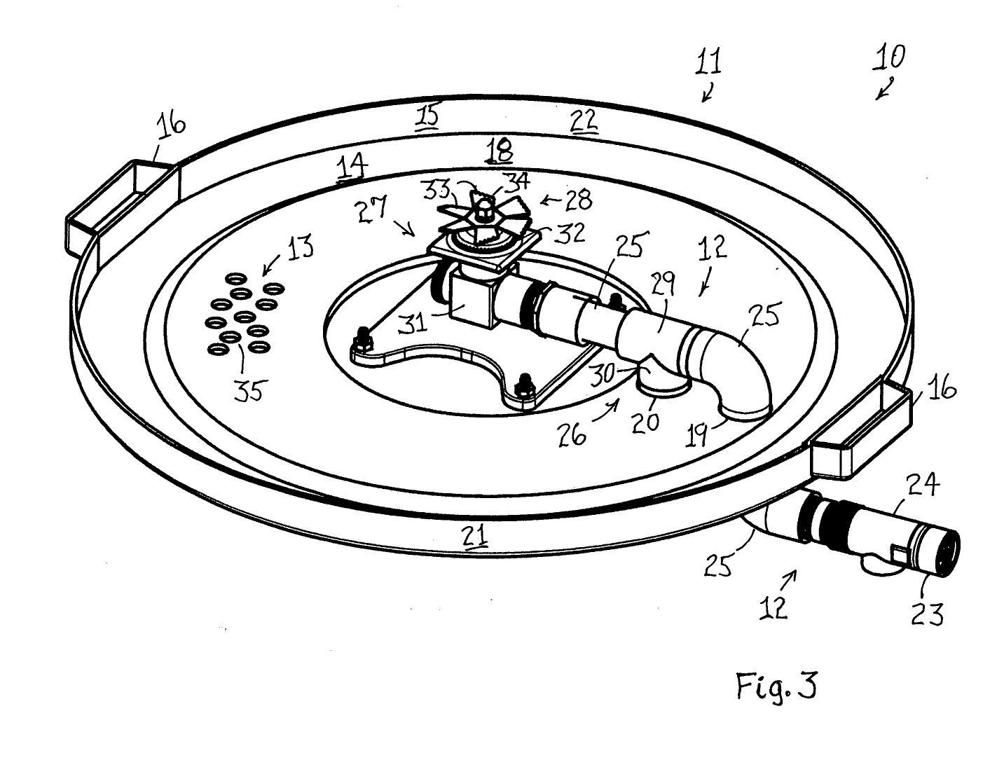

Referring to FIGS. 1-3, a trash can cleaning lid according to the preferred embodiment of the present invention 10 comprises a basic lid 11, a plurality of cleaning mechanicals 12, and a debris strainer 13.

The basic lid 11 is a conventional trash can lid comprising a disk-shaped top mantle 14 from which downwardly depends a short vertical cylindrical side flange 15, and further comprising one or more handles 16 which may be attached to either the top mantle 14 or the side flange 15. The top mantle 14 has an upper surface 17 and an under surface 18, which two surfaces communicate through two round apertures: a water aperture 19 and a cleanser aperture 20. The side flange 15 has an exterior surface 21 and an interior surface 22, the latter of which can optionally have one or more treads or ridges designed to cooperate with corresponding structures on the outer rim of the trash can (not shown).

The cleaning mechanicals 12 comprise a hose coupling 23, a shut-off valve 24, a plurality of fluid transmission means 25, a cleanser reservoir 26, a spray-head mechanism 27, and a rotating water deflector 28. The hose coupling 23 extends above the upper surface 17 of the top mantle 14 and consists of a fitting into which the male end of a standard garden hose (not shown) can be inserted or screwed. Downstream of the hose coupling 23 is the shut-off valve 24, which is one of the standard types used in plumbing. The fluid transmission means 25 consist of a series of interconnected plumbing fittings, including elbows and T-joints, which form a continuous fluid conduit that conveys water from the shut-off valve 24 though the water aperture 19, into the cleanser reservoir 26 and then into the spray-head mechanism 27.

The cleanser reservoir 26 extends through the cleanser aperture 20 from above the upper surface 17 to below the under surface 18 of the top mantle 14. The spray-head mechanism 27 is fastened to the under surface 18 of the top mantle 14. The cleanser reservoir 26 comprises a reservoir fitting 29, which can be a T-joint fitting, and a filling fitting 30, which extends though the cleanser aperture 20 and projects above the upper surface 17 of the top mantle 14, such that a cleanser (not shown) can be poured through the filling fitting 30 into the reservoir fitting 29. The flow of water from the hose coupling 23 mixes with the cleanser in the reservoir fitting 29 so that a water/cleanser emulsion flows out of the reservoir fitting 29 into the spray-head mechanism 27.

The spray-head mechanism 27 comprises a chamber 31 and a nozzle 32, the latter of which constricts the flow of water/cleanser emulsion and thereby increases its pressure. The nozzle 32 directs a concentrated jet of pressurized water/cleanser emulsion downward to the rotary water deflector 28, which comprises a plurality of angled blades 33 rotatably attached to a common axis 34. The rotary water deflector 28 propagates a rotary spray of pressurized water/cleanser emulsion against the interior walls of the trash can (not shown), thereby flushing wastes from the interior walls to the bottom of the trash can.

The debris strainer 13 comprises a filtering means 35, which consists of one or more openings in the top mantle 14, some or all of which openings can encompass or be covered by a metal, plastic or fabric mesh, screen, filter or sieve. Over the filtering means 35 is slidably attached a cover plate 36. When the cover plate 36 is in the closed position, it forms a water-tight seal over the filtering means 35. When the cover plate 36 is in the open position, liquids may flow through the filtering means from the inside of the trash can, but solid debris is retained by the filtering means 35. When the shut off valve 24 is opened and the trash can is being cleaned, the cover plate 36 is kept in the closed position to prevent contaminated liquid from escaping. After all wastes have been flushed from the interior walls to the bottom of the trash can, the shut-off valve is closed 24 and the hose is disconnected from the hose coupling 23. Then the cover plate 36 is opened and the trash can is tilted to a semi-inverted position to allow filtered wastewater to flow out of the trash can. The lid 10 is then removed from the trash can, and the debris trapped in the debris strainer 13 is dumped into a garbage bag inserted in the freshly cleaned trash can.

The pipe and fittings used in the preferred embodiment 10 are preferably made of PVC plastic, but they may also be made of any other plastic or metal material used in fabricating plumbing supplies, pipes and/or fittings.

While the present invention 10 has been described with respect to a preferred embodiment, those skilled in the art will be capable of producing a number of alternate embodiments based on this disclosure, all of which are intended to be encompassed within the scope and spirit of the appended claims.

What is claimed is:

1. A trash can cleaning lid, which is designed to fit snuggly over a conventional household trash can having an outer rim, interior walls and a bottom, the trash can cleaning lid comprising:
a basic lid, a plurality of cleaning mechanicals, and a debris strainer, wherein
the basic lid comprises a disk-shaped top mantle, from which downwardly depends a short vertical cylindrical side flange, which top mantle has an upper surface and an under surface, such that the upper and under surfaces communicate through a water aperture and a cleanser aperture, and the basic lid further comprises one or more handles which may be attached to either the top mantle or the side flange; and
the cleaning mechanicals comprise a hose coupling, a shut-off valve, a plurality of fluid transmission means, a cleanser reservoir, a spray-head mechanism, and a rotating water deflector, wherein the hose coupling extends above the upper surface of the top mantle and consists of a fitting into which the male end of a standard garden hose can be inserted or screwed, and wherein the hose coupling is in fluid communication with the shut-off valve, and wherein the fluid transmission means consist of a series of interconnected plumbing fittings, which form a continuous fluid conduit that conveys water from the shut-off valve though the water aperture into the cleanser reservoir and then into the spray-head mechanism, and wherein the cleanser reservoir contains a cleanser, which consists of one or more cleaning, deodorizing and/or disinfecting agents, such that a flow of water from the hose coupling mixes with the cleanser in the cleanser reservoir, thereby generating a flow of a water/cleanser emulsion out of the cleanser reservoir into the spray-head mechanism, and wherein the spray-head mechanism comprises a chamber, into which the water/cleanser emulsion flows, and a nozzle, which constricts the flow of the water/cleanser emulsion and thereby increases its pressure, such that the nozzle directs a concentrated jet of pressurized water/cleanser emulsion downward to the rotary water deflector, which propagates a rotary spray of pressurized water/cleanser emulsion against the interior walls of the trash can, thereby flushing wastes from the interior walls to the bottom of the trash can; and
the debris strainer comprises a filtering means, which. consists of one or more openings in the top mantle, some or all of which openings can encompass or be covered by a metal, plastic or fabric mesh, screen, filter or sieve.

2. The trash can cleaning lid according to claim 1, wherein the cleanser reservoir extends through the cleanser aperture from above the upper surface to below the under surface of the top mantle, and the spray-head mechanism is fastened to the under surface of the top mantle, and wherein the cleanser reservoir comprises a reservoir fitting and a filling fitting, the latter of which extends though the cleanser aperture and projects above the upper surface of the top mantle, such that the cleanser can be poured through the filling fitting into the reservoir fitting, thereby replenishing the cleanser in the cleanser reservoir.

3. The trash can cleaning lid according to either of claims 1 or 2, wherein the rotary water deflector comprises a plurality of angled blades rotatably attached to a common axis.

4. The trash can cleaning lid according to either of claims 1 or 2, wherein a cover plate is slidably attached over the filtering means, such that, when the cover plate is in a closed position, it forms a water-tight seal over the filtering means, and such that, when the cover plate is in an open position, liquids can flow through the filtering means from the inside of the trash can, but solid debris is retained by the filtering means.

5. The trash can cleaning lid according to claim 3, wherein a cover plate is slidably attached over the filtering means, such that, when the cover plate is in a closed position, it forms a water-tight seal over the filtering means, and such that, when the cover plate is in an open position, liquids can flow through the filtering means from the inside of the trash can, but solid debris is retained by the filtering means.

6. The trash can cleaning lid according to either of claims 1 or 2, wherein the side flange has an interior surface that has one or more treads or ridges designed to cooperate with corresponding structures on the outer rim of the trash can, so as to enable more secure attachment of the lid to the trash can.

7. The trash can cleaning lid according to claim 3, wherein the side flange has an interior surface that has one or more treads or ridges designed to cooperate with corresponding structures on the outer rim of the trash can, so as to enable more secure attachment of the lid to the trash can.

8. The trash can cleaning lid according to claim 4, wherein the side flange has an interior surface that has one or more treads or ridges designed to cooperate with corresponding structures on the outer rim of the trash can, so as to enable more secure attachment of the lid to the trash can.

9. The trash can cleaning lid according to claim 5, wherein the side flange has an interior surface that has one or more treads or ridges designed to cooperate with corresponding structures on the outer rim of the trash can, so as to enable more secure attachment of the lid to the trash can.
